(19) United States
(12) Patent Application Publication
(10) Pub. No.: US 2006/0074180 A1
(43) Pub. Date: Apr. 6, 2006

(54) Powder-free coagulants with silicone surfactants

(76) Inventor: Timothy M. Lipinski, Marietta, GA (US)

Correspondence Address: KIMBERLY-CLARK WORLDWIDE, INC., 401 NORTH LAKE STREET, NEENAH, WI, 54956, US

(21) Appl. No.: 10/953,641

(22) Filed: Sep. 29, 2004

(51) Int. Cl. C08L 83/04; B29C 33/56; B03D 1/00

(52) U.S. Cl. 524/588; 264/240

(57) ABSTRACT

A coagulant formulation having a miscible silicone surfactant in the coagulant, which can be applied directly to a bare mold surface and replace powder-based release agents, along with a method of using the coagulant in the manufacture of shaped, elastomeric products is provided. The silicone surfactant forms a smooth surface, from which a shaped article can be easily stripped, and which does not require a post-curing halogenation process to remove powder particles.

### FIELD OF THE INVENTION

The present invention pertains to coagulant compositions for use in the manufacture of elastomeric articles. More particularly, the present invention concerns the surface of molds and the final external surface of shaped articles.

### BACKGROUND

Natural and synthetic-material polymers, such as polyisoprene, nitrile rubber, vinyl, polyvinylchloride, polychloroprene, or polyurethane materials, which exhibit good barrier properties, and good moldability, processibility, and physical properties upon curing, have been useful in the production of many different elastomeric articles or products for a variety of applications, in fields such as medical devices, healthcare, industrial, or consumer products, or novelty items. Such articles, in addition to having good elastic properties, exhibit good strength characteristics and can be produced to be impermeable not only to aqueous solutions, but also many solvents and oils. As the desire for good barrier-control has increase and expanded in many areas of daily life, elastomeric articles have provided an effective barrier between the wear and the environment, successfully protecting both from cross-contamination.

In the manufacture of elastomeric or polymer latex products, such as surgical, examination, or work gloves, prophylactics, catheters, balloons, tubing, and the like, a coagulant solution is often first applied to a mold. Over the coagulant, a layer of polymer latex is coated. Coagulant solutions include salts that neutralize the surfactants in latex emulsions, and which locally destabilizes the latex and causes the latex emulsion to gel and adhere as a film on the surface of the mold. A long-standing problem associated with the fabrication process, in particular with dipping techniques, has been the inability to easily remove the shaped product from the mold. Conventionally, a mold-release agent, such as calcium carbonate, talcum, or other powders, has been employed to help release the product from the mold. These powders are applied to the mold surface along with the coagulant before the mold is coated with a latex layer. Powdered articles, however, typically require a subsequent halogenation and rinsing process to remove the powder particles when a powder-free product is desired.

For example, commercially available powder-free natural rubber and synthetic elastomer gloves are typically manufactured by first preparing a powdered glove having conventional latex using dipping technology and manufacturing techniques. The gloves are then post-processed offline to remove powder by chlorination or acid treatment, followed by rinsing.

Both of these backend processes can remove powders which have been deposited on the glove during the manufacture processes, however, they also have several disadvantages. For instance, post-processing can be time and labor-intensive. Chlorination, for example, is a multi-step process that first requires that the gloves be removed from their molds, or formers, and turned inside out. The gloves are then subjected to several cycles of chlorination, neutralization, rinsing, glove inverting and drying operation steps. In the normal operating cycle for producing powder-free gloves, at least two manual glove turning steps are required. Since the inner surface or donning side of the glove is the side that is to be chlorinated, once it has been stripped from its former, the glove needs to be first turned inside out such that the inner surface is on the exterior. After the glove is chlorinated, the glove needs then to be manually re-inverted so that the freshly chlorinated donning side is returned to the interior of the glove. As a result, post-processing chlorination is also costly. Another issue associated with chlorination is that the chlorination process may degrade the polymeric coating applied to the glove surfaces to render the glove powder-free. Further, halogenation-associated glove degradation results in poor glove donning, gloves stick to each other on the coated side, and have poor coating adhesion and flaking of the coating.

The trend in recent years among consumers in certain industries or communities to transition away from powdered to powder-free products, because of, for instance, the fear of wound contamination by powder particles, especially for medical examination or surgical gloves, and pursuit of better donning properties and hand-feel, has further accentuated the desire for a powder-free alternative solution to this release agent problem. Hence, a need exists for a new approach that does not use powder release agents, and which can simplifying the release and overall manufacturing process.

### SUMMARY OF THE INVENTION

In response to the problems associated with conventional release agents, a new coagulant formulation has been developed. The invention discloses, in part, compositions or formulations for coagulant solutions containing silicone surfactants, and methods for their preparation and use. These compositions may be used in the fabrication of shaped latex or other polymer material-based articles.

According to the invention, the coagulant composition or formulation includes a silicone surfactant that is miscible in either an aqueous or solvent based medium; a mono-, a di-, or a trivalent metallic salt or combinations thereof; and optionally wetting agents or defoamers. In particular, the material composition, in weight percent, may include: about 5-50% of a coagulant salt or acid, about 0.001-85% silicone surfactant; about 50-90% aqueous or alcohol solvent; and an effective amount of up to about 2% of a defoamer, and/or up to about 3% of an additional wetting agent. The silicone surfactant may include a poly-methylsiloxane backbone. The acidic coagulants may be selected from hydrochloric, formic, or acetic acids. The mono-, di-, or trivalent metallic salts, or combinations thereof, preferably, are aqueous soluble, and may include the nitrate, sulfate, or chloride salts of calcium, magnesium, aluminum, zinc, or ammonium. (Calcium or magnesium carbonate or stearate, which do not easily dissolved in aqueous or organic solutions are tolerable, but not preferred.) Addition of granular particles may be tolerated for modifying surface tack or creating grip surfaces, but such additives are not encouraged, if the desire is to form a blemish-free outer surface.

The invention encompasses a method for preparing and using a coagulant solution that includes the steps of: a) providing an aqueous- or solvent-miscible silicone surfactant; b) providing an aqueous or solvent-based coagulant solution having either a mono-, di-, trivalent metallic salt or combinations thereof, and optionally wetting agents or defoamers; c) mixing together said silicone surfactant and coagulant solution; and d) applying the prepared solution directly to a prepared surface. The method further involves heating the prepared solution to a temperature of up to about 60° C., desirably to a temperature of between about 15° C. to 45° C. or 55° C. The silicone surfactant coagulant solution may be applied directly to the surface of a mold without fear of fouling the surface, that is, contamination of a surface by a non-water soluble material, especially one that inhibits subsequent wetting of the surface. Traditionally, silicone or silicone-based materials are to be avoided for preparing the surfaces of molds used for elastomeric products.

In a further aspect, the invention relates a method for fabricating a polymeric article. The method entails: providing a mold having a cleaned and prepared surface; providing a composition for a coagulant solution having a silicone surfactant that is miscible in either an aqueous or solvent based solution, either a mono-, di-, trivalent metallic salt or combinations thereof, and optionally wetting agents or defoamers; applying a coating of the coagulant solution to the mold surface; applying a coating of either a polymer-containing liquid, a colloidal emulsion, or a solvent-based polymer medium to the coagulant-coated mold surface; removing salt residue from the article; drying and curing said article. The silicone surfactant in the coagulant solution is applied directly to the mold surface, and the mold surface is powder-free. It is believed that the silicone surfactant lowers surface tension on the mold surface and increases the surface's wetting potential. That is, the silicone surfactant-coated surface exhibits a greater susceptibility to good wetting by either a polymer-containing liquid, an colloidal emulsion, or a solvent-based polymer medium than a comparable mold surface not coated with said silicone surfactant. The surface tension of the coated-mold surface should be ≦45 dynes/cm, desirably ≦40 or 35 dynes/cm, or about 1-30 dynes/cm.

Lastly, the present invention pertains to a polymeric article fabricated using the present coagulant compositions and according to the present methods. The polymeric article is characterized as having a power-free outer or gripping surface, which is not halogen processed (i.e., the surface should not have a halogen residue), and has at least a residual amount of a silicone surfactant on at least a portion the outer surface. Preferably the residue of silicone surfactant is present in a substantially even coating on the outer or final surface. The exterior surface has a fine, smooth or even surface, which may or may not be textured for better gripping, and that is absent surface defects. The gripping surface also has substantially no block resistance for the surface to slide over against itself.

The inventive compositions can eliminate the need to use powders as release agents in the manufacture of latex or polymer products, such as gloves, catheters, finger cots, breather bags, balloons, or condoms. The incorporation of silicone surfactants also can enhance the effective wetting of the powder-free coagulant solution onto the surface of molds or formers. The presence of silicone surfactant in solution promotes a more uniform, even coverage of the coagulant solution over the mold surface. This phenomenon produces a more uniform distribution that avoids the usual tendency of the coagulant solution to pool or distribute unevenly across the mold surface, a problem commonly associate with the use of powder containing solutions. Powder particles, it is believed, contribute in part to interfacial surface tension between the powder particles and the coagulant solution, which increases the tendency for runs, drips, flow marks, and/or signs of uneven distribution on the polymer-coated surface and finished product.

Even when starting with a mold having a roughened or bisque ceramic surface, one can create a mold surface that appears smooth and glassy, without irregularities, when coated with the present silicone surfactant-containing coagulant solution. Hence, products made on molds coated with the silicone surfactant solutions tend to have a finished, exterior surfaces that appears finer or smoother, even if textured, without mottling, and has a more consistent quality than those fabricated with powder-containing coagulants. This advantageous attribute enables one to produce shaped articles that have very even and virtually defect-free surfaces.

Furthermore, with the use of the present silicone surfactant-containing solutions, one can achieve a fully online manufacturing process in which one need not remove the shaped articles from their molds until just before the final fabrication stages, such as stripping from the mold and packing. The articles can be manufactured without the need for costly halogenation processing to remove powder residues and other traditionally backend, offline processes. Furthermore, after the molded product is stripped from the mold, the residual silicone surfactant on the outer or gripping surface of the finished product can reduce the tackiness of product surface and the tendency for individual product items to stick together in packing.

Additional features and advantages of the present coagulant compositions and associated methods will be disclosed in the following detailed description. It is understood that both the foregoing summary and the following detailed description and examples are merely representative of the invention, and are intended to provide an overview for understanding the invention as claimed.

### BRIEF DESCRIPTION OF THE FIGURES

FIG. 1 is a schematic representation of a glove, according to the present invention.

FIGS. 2A-C are optical microscopy (OM) images, collected at 10× linear magnification, of the mold-contacting side of the surface of three gloves taken under low-angle surface lighting.

FIGS. 2A and 2B show glove surfaces made according to the present invention. In FIG. 2A, the glove is made using only a silicone surfactant, and in FIG. 2B, the glove is made, alternatively, with a fine powder and the silicone surfactant. FIG. 2C is the surface of a glove, after chlorination, formed using a conventional powder-containing coagulant solution, which serves as a control.

FIGS. 3A-C are OM images, collected at 20× linear magnification, of the three gloves of FIGS. 2A-C. FIGS. 3A and 3B show glove surfaces made according to the present invention, while FIG. 3C serves as a control.

FIGS. 4A and 4B, are OM images of a scale with 2 mm total length, at 10× and 20× linear magnifications, respectively.

FIGS. 5A and 5B, are photos of the surface of a former coated with a fresh layer of the present silicone surfactant coagulant, before drying.

FIG. 5C shows the surface of a former coated with the powder-free silicone surfactant coagulant, slightly dried.

FIGS. 6A, 6B, and 6C are photos of the surface of a mold/former coated with a slightly dried, conventional powdered coagulant.

### DETAILED DESCRIPTION OF THE INVENTION

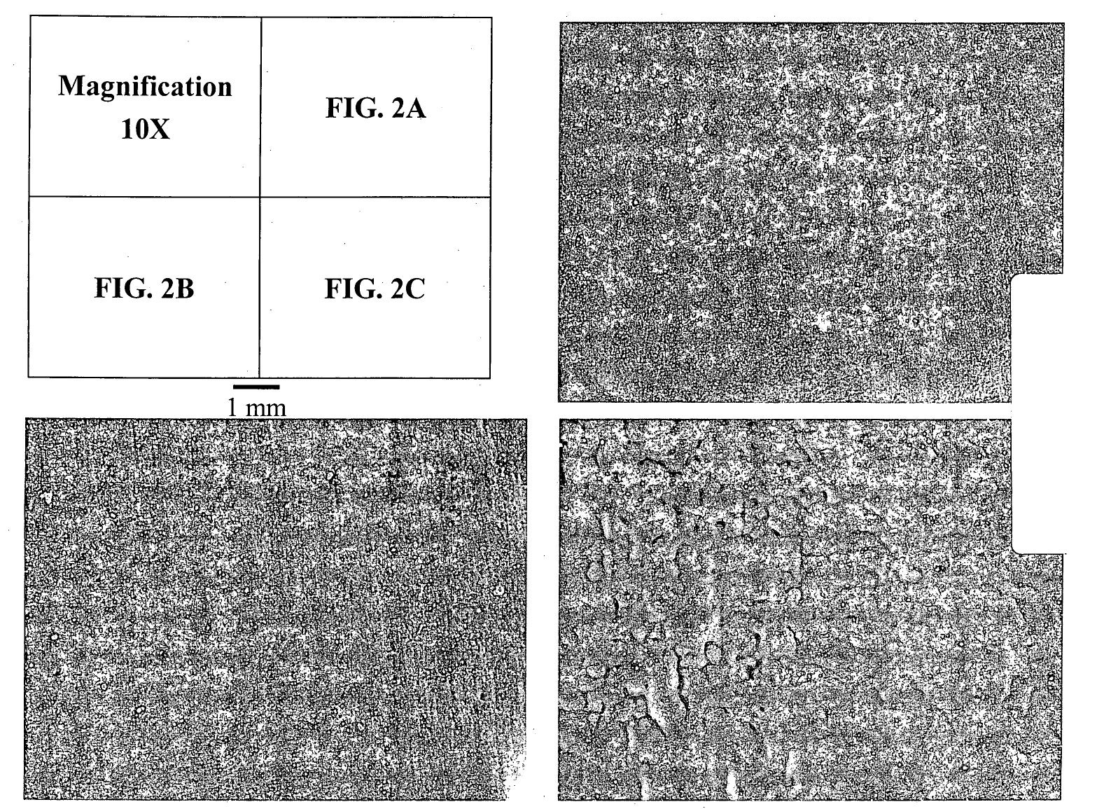

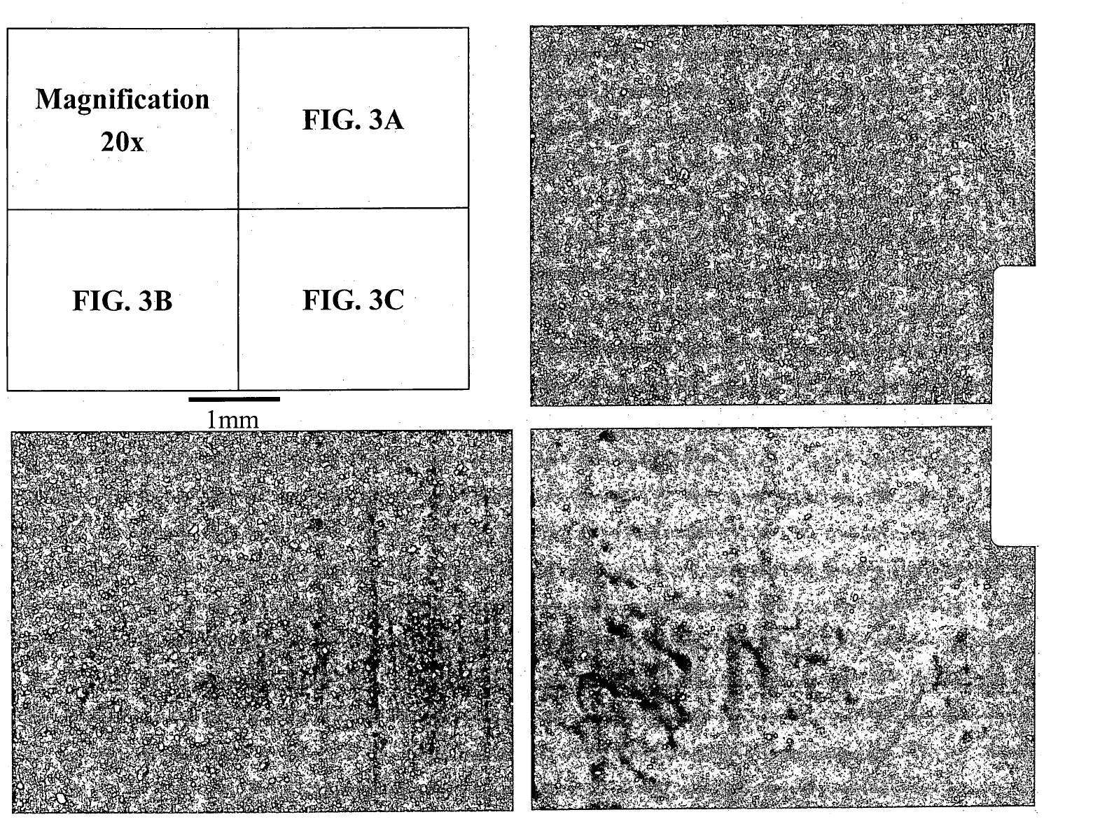

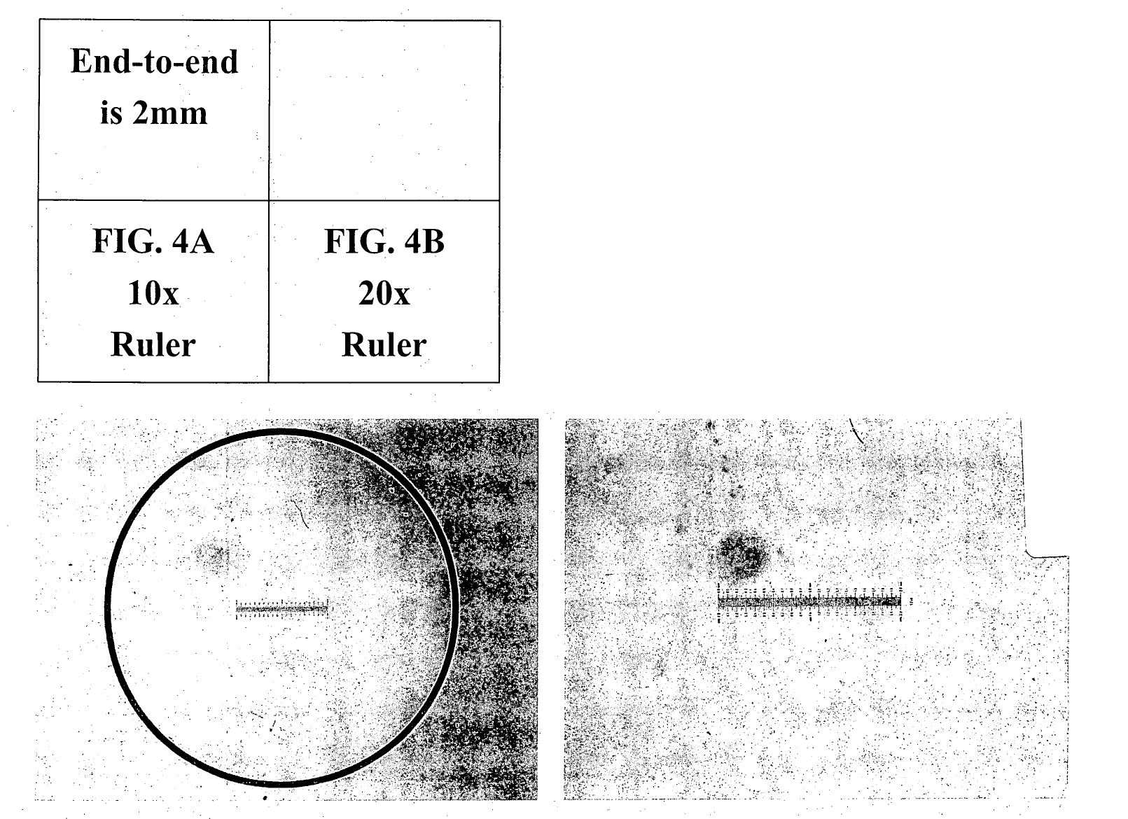

In the manufacture of polymeric or elastomeric articles, such as gloves or condoms, a powder-based release agent has commonly been applied to the mold surface either in a coagulant or as a release agent. The presence of powder particles on articles, however, has many associated problems, as discussed previously. Further, the process of removing powder particles from the articles can be complex. To overcome the problems and complications associated with conventional powder-and-remove production techniques for making powder-free products, we have discovered, according to the present invention, a new technique that is powder-free ab initio for removing shaped polymer articles from their molds. The present invention involves incorporating a silicone surfactant component into a coagulant solution or dispersion. As used herein, the term “powder-free” refers to shaped or molded articles and associated manufacturing processes or other applications that avoid utilizing powdered or finely-divided materials coated on a mold or shaping surface as either a coagulant or release agent. Generally speaking, these articles may be characterized by a complete or substantial absence of powder particles on the article surfaces as determined by optical or electron microscopy. The associated manufacturing processes may be characterized by an absence of the use of powder as a release agent, and may also forego rinsing and/or halogenation steps. This is not to say, however, that the present inventive formulations and processes are limited only to powder-free embodiments or species. Rather, the present invention still can exhibit the features and associated advantages over conventional approaches as described herein even when fine powders are present in the coagulant solution. A visual comparison of examples made with a coagulant solution containing silicone surfactant alone, in FIGS. 2A and 3A, and examples made with a coagulant solution containing silicone surfactant and a fine powder, in FIGS. 2B and 3B, show little qualitative difference in the appearance of the material surface between the two sets. That is, both surfaces exhibit an even, uniform or smooth appearance under 10× to 20× linear magnification using conventional optical microscopy techniques.

Previously, silicone-based compounds were used as desirable lubricating agents on shaped or molded articles. For instance, the silicone was applied either to the donning side of a glove, after the glove is dipped and still on the mold, or once they have been removed from its mold. Traditionally, however, it has been difficult, if not impossible, to use silicone-based materials as release agents in the fabrication of polymer articles. Silicone mold release agents have been used in dry rubber processes such as compression molding, but not for wet techniques. Most silicone materials tend to contaminate the mold surfaces and cause very poor wetting. In other words, commonly, if silicone materials contact a mold or former surface, they tend to greatly decrease the wettability of the mold surface making the surface less susceptible to subsequent wetting with aqueous or solvent-based solutions or latex coatings. Further, silicone is difficult to remove once the wetting surface chemistry of mold surfaces becomes fouled. Fouling refers to the contamination of a surface by a non-water soluble material that inhibits subsequent wetting of the surface. Conventionally, silane molecules bond instantly, on contact, to the substrate material to form a slippery surface. This kind of surface is one, conventionally, that has been avoided in dip-coating processes. The present modified organosilane or siloxane surfactants solutions takes advantage of this property of silanes, and overcomes the wetting issues. Once a surface becomes fouled, further application of other coatings or layers becomes difficult, if not impossible. For such reasons, silicone-based materials are not favored and ordinarily have not been used in coagulant solutions that directly contact a naked mold surface.

The present invention, in contrast, employs a coagulant solution having a silicone surfactant that is applied directly to a mold or former surface. The silicone surfactant is added to an aqueous solution of coagulant salts, along with a small amount of defoamer. The resulting mixture may be used as a coagulant, in particular for dip-technique manufacture. The coagulant formulations contain silicone surfactants that are soluble or dispersible in water or other solvent-based solutions. The present formulation is not a silicone emulsion, which is a material that all glove manufacturers wish to avoid because it fouls the molds. Rather, the silicone molecules are modified with aqueous or other solvent-miscible substituents. As used herein, the term “silicone” generally refers to a broad family of synthetic polymers that have a repeating silicon-oxygen backbone, which may be molecules of at least one type of organosilane, siloxane, or silanol, including, but not limited to, polydimethylsiloxane and polysiloxanes having hydrogen-bonding functional groups. The molecules of organosilane or siloxanes each have a R-group appended to the silicone-oxygen backbone. Desirably, the R-group substitutents confer aqueous or polar solubility, which lend a hydrophilic character to the entire molecule. (See, 37. “Polymer Surface Modifiers”, I. Yilgor, in “Silicone Surfactants”, ed. R. M. Hill, Surfactant Science, Vol. 86, Ch. 10, Marcel Dekker, N.Y., 1999, ISBN 0-8247-0010-4, pp. 259-273.) A direct correlation exists between the number of soluble R-group substituents on each molecule and the degree of miscibility of the silicone molecules in aqueous or other polar solvents. It is believed that the solubility of the silicone molecules should be proportionate to the number and length of the R-group substituents. In other words, the greater the number and length or relative molecular weight of soluble functionalities the better the silicone surfactant performs within the present coagulant solution.

In general, the present coagulant compositions may include, in weight percent, about 5-45% of a coagulant salt or acid (preferably about 10-35%, more preferably about 15-30%, or typically about 20-27%); about 0.001-80% silicone-based surfactant (preferably about 0.05-20% or 0.07-15%, or more preferably about 0.1-6%, or typically about 0.1-3% or 0.1-2%); about 50-90% of water or an alcohol solvent (preferably about 55-85%, more preferably about 70-80%); and from 0% to an effective amount of up to about 0.1 or 1.5% (preferably, ˜1%) of a defoamer, and/or about 0.01-3% (preferably, ˜1.5%) of an additional wetting agent. Specific compositional embodiments may vary depending on the particular environmental situation or conditions of use or production, and/or material properties desired in the resultant elastomeric, shaped article. For instance, such conditions or desirable properties may include the type of former surface (e.g., glazed, roughened, bisque, etc.), processing temperatures for formers and coagulants, desired glove thicknesses, type of polymers used for the glove, or amount of grip desired from the glove surface for specific application, etc.

Generally, in mixing the coagulant solution, any type of water may be used, as long as the water is clean and free of copper ions, which can degrade natural rubber latex. In certain embodiments, deionized water is preferred. Sometimes water prepared using reverse osmosis is employed. An organic or alcohol solvent may be selected from, for example, ethanol or an ethanol-acetone mixture, methanol, propanol, or alcohol/water mixtures (e.g., polyvinyl alcohol). Suitable wetting agent emulsifiers include non-ionic ethoxylated alkyl phenols such as octylphenoxy polyethoxyethanol or other non-ionic wetting agents. Defoamer may be chosen from naphthalene-type defoamers, silicone-type defoamers and other non-hydrocarbon-type defoamers.

Hundreds of different, silicone compounds potentially can be used in the present inventive coagulant solution. According to certain embodiments, the silicone surfactant can be expressed with the general structural formula according to the following: 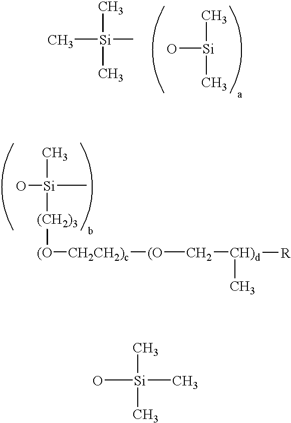
where, R is a —CH₃, —OH, alkyl alcohol, or alkyl polyol group; a, c, and d are integers greater than 0; and b≧1. The greater the number of b, c, or d units the more soluble the silicone surfactant is in solution. An upper limit of a, b, c and d can be determined by a person of ordinary skill without undue experimentation. In certain embodiments, a and b can practically be limited to a number of these segments that still allow solubility or dispersibility in the water or solvent used to prepare the coagulant. The value of c and d can be limited by a reasonable ratio of c/d groups to a/b groups to allow both solubility/dispersibility and the release/lubrication characteristics imparted by sufficient silicone containing groups. Other R-group substituents or functional groups that impart increased water solubility may include hydrocarbon or fluorocarbon structures selected from the following group: alkyl, branched, unbranched, phenylated. Other potential R-group substituents may include amino, carboxyl, hydroxyl, ether, polyether, aldehyde, ketone, amide, ester, and thiol groups.

For instance, in some embodiments, according to the present invention, the silicone component may be polydimethylsiloxanes and/or modified polysiloxanes. Some suitable modified polysiloxanes that may be used in the present invention include, but are not limited to, phenyl-modified polysiloxanes, vinyl-modified polysiloxanes, methyl-modified polysiloxanes, fluoro-modified polysiloxanes, alkyl-modified polysiloxanes, alkoxy-modified polysiloxanes, amino-modified polysiloxanes, and combinations thereof. Examples of commercially available silicones that may be used with the present invention include DC5211 and DC3058 available from Dow Corning Corporation (Midland, Mich.), Masil SF-19 available from BASF (Badische Anilin und Soda Fabrik) Corporation (Wickliffe, Ohio), and SM 2140 available from GE Silicones (Waterford, N.Y.). It should be understood, that any silicone that is miscible in either an aqueous or organic solvent and provides a lubricating effect between a former and subsequently applied elastomeric polymer material coatings may be used. In some embodiments, the silicone backbone may have side branches that contain polyols. Polyols, a generic name for low molecular weight, water-soluble polymers and oligomers containing a large number of hydroxyl groups, which help with miscibility. Specific examples include glycols, polyglycols and polyglycerols.

It is believed that the silicone-containing molecules in the coagulant solutions are amphiphilic in solution. The organic molecule has a polar head, where a leaving group can react with other groups located on the surface of the substrate material to form covalent bonds linking the organic molecule with the substrate. Preferably, the silicone-containing molecules may include silanes or siloxanes possessing a hydrocarbon or fluorocarbon structure and at least one leaving group that can form a covalent bond with hydroxyl groups located on the surface of the mold substrate.

The present coagulant formulations allows one to easily removal shaped articles, such as of gloves, condoms, or balloons, from their molds without the use of powder. It uses modified silicone based materials that do not foul the molds. It is believed that these specialty types of modified silicone materials have not been used as aids in stripping shaped articles from molds. In the coagulant, the lubricative properties of the silicone containing molecules create a smooth, even surface and eliminate the adhesion of particulates that can mar the surface and potentially cause surface damage. Moreover, as people become more aware of potential contamination, infection, or skin irritation issues, especially for medical or surgical applications, and the presence of powder on articles becomes increasingly less favored, the use and demand for powder-free articles and other products are becoming increasingly widespread.

Whereas conventionally, one would need to apply two different compounds to perform the two functions of coating a former with latex and for stripping, the silicone surfactant serves as both a wetting agent and a release agent. The combination of functions with a single kind of material and a single coating step simplifies the manufacturing process, lowers the cost, and can increase overall speed of production. Treatment of the prepared mold surface with the inventive coagulant allows one to create a fully online, automated fabrication process. The molded glove does not require stripping from the former to permit conventional off-line processes to be performed, such as polymer coating or halogenation to remove powder particles from the outer or grip side of the glove. Hence, each glove remains on the its former through all of the automated processing and coating steps until it is ready to be stripped form the former and packed. These formerly off-line, backend processes were often time consuming and costly. The present automation friendly attribute potentially can both save on costs and reduce production time. Any associated increase in production speed may lead to commercial advantage.

When combined with an online coating or halogenation process for the donning or inner surface of a glove, the present silicone-surfactant coagulant solutions allow one to operate a true strip and pack manufacturing production line, which eliminates the need for further backend processing such as halogenation, powder removal, washing, tumbling, lubricant application, or off-line drying.

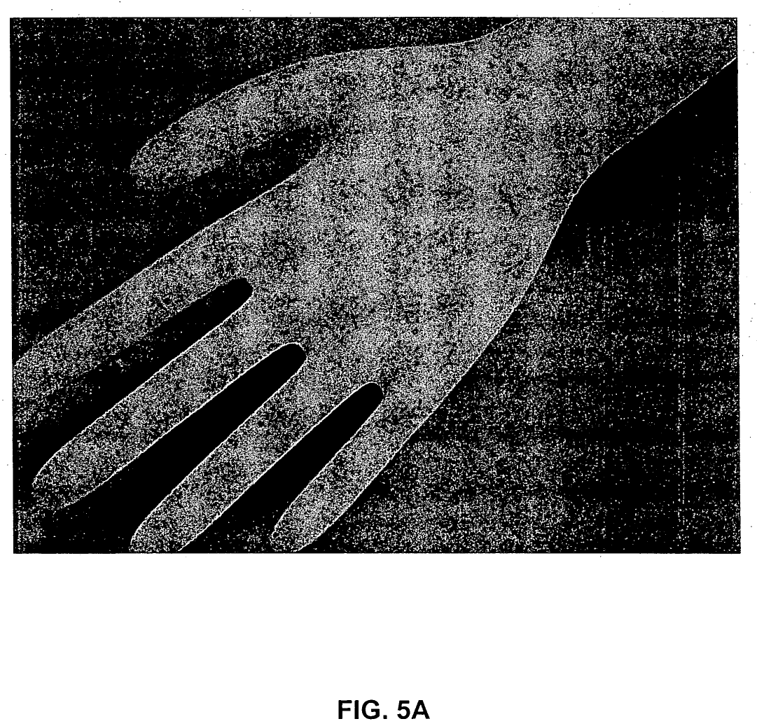

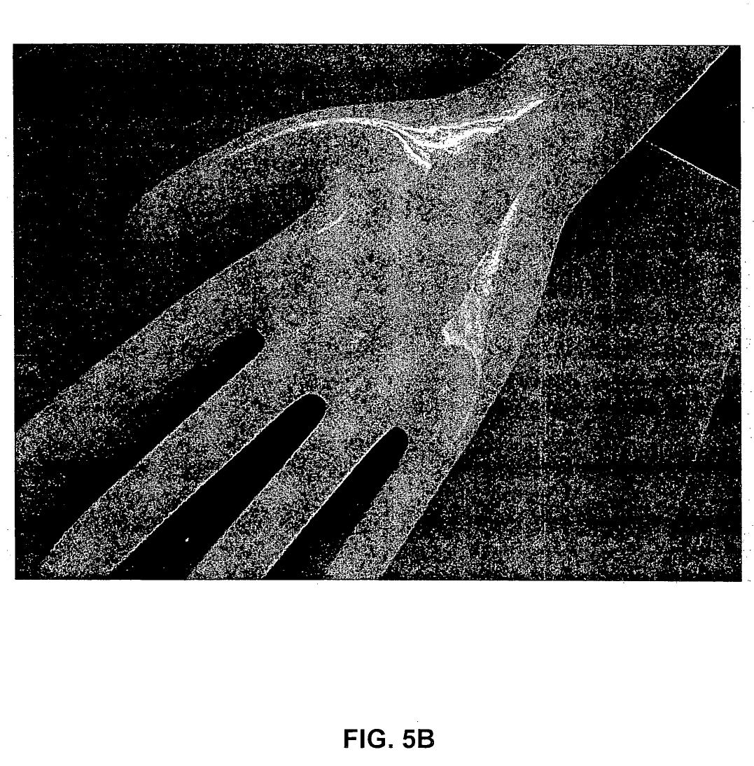

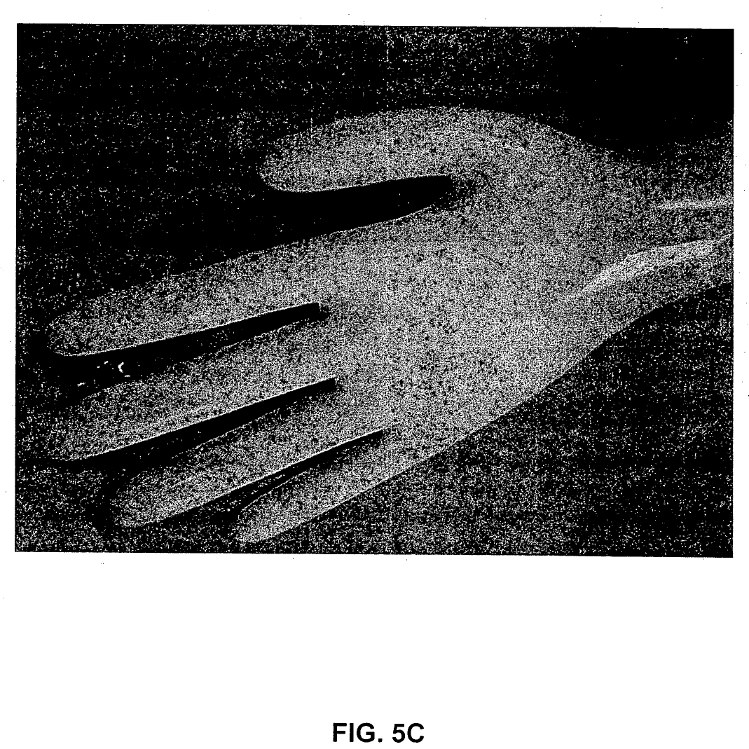

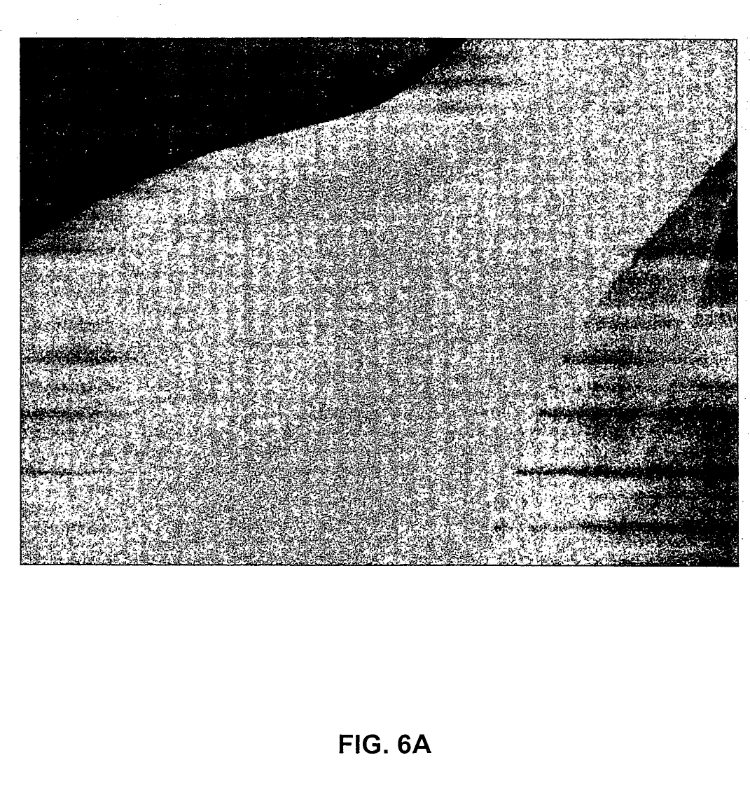

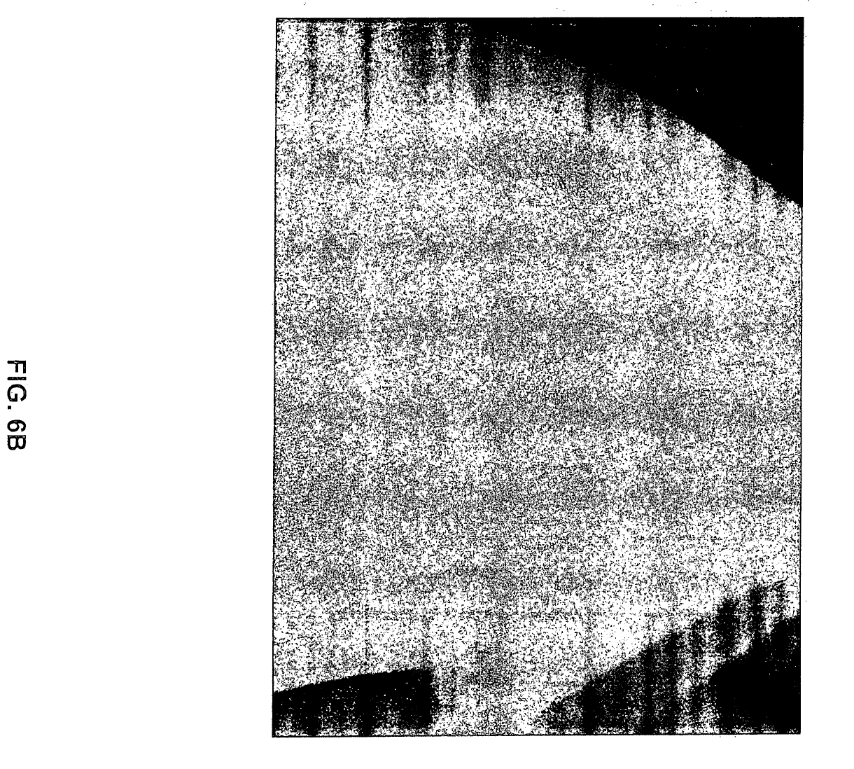

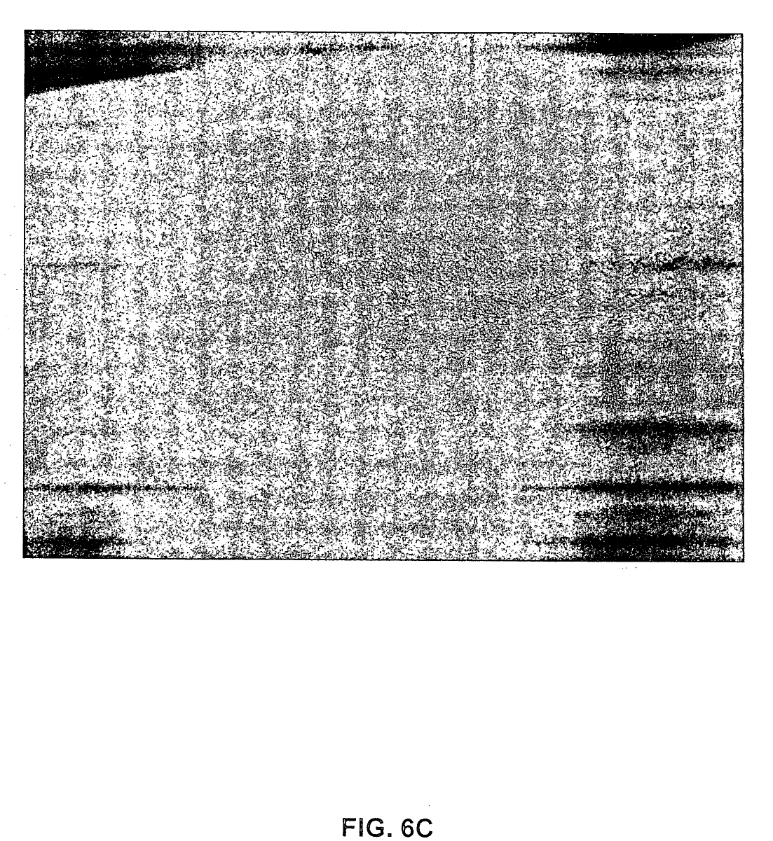

Another advantage of the present coagulant formulation is its tendency to create a smooth, glassy surface, even on ceramic molds with a bisque surface. A “smooth, glassy” surface refers to an even or uniform surface characterized by lack of surface blemishes, and having a sheen to the surface when wet (and even when partially dried), such as shown in FIGS. 5A-5C. In contrast to a conventional powdered surface, shown in FIGS. 6A-6C, the glassy surface is substantially beyond the effect of, or is free of microscale surface irregularities. In some embodiments, “glassy” encompasses a surface characterized by an absence of sub-millimeter sized gaps or fissures of the type that can be observed in FIGS. 2C and 3C. The creation of relatively macroscale surface features that are intentional, such as ridges or bumps and pimples, for enhancing friction or grip, however, will show through and will likely not be effected detrimentally.

The silicone surfactants are believed to be effective in lowering the surface tension of the coagulant solution. A lower surface tension allows the coagulant to spread out over the mold surface more uniformly, and create a more even coating without runs or puddling as observed conventionally. This phenomenon allows one to form a polymer latex film or surface that does not suffer from blemishes, such as runs and other surface defects, which can detrimentally impact the longevity, strength, and performance of the molded article.

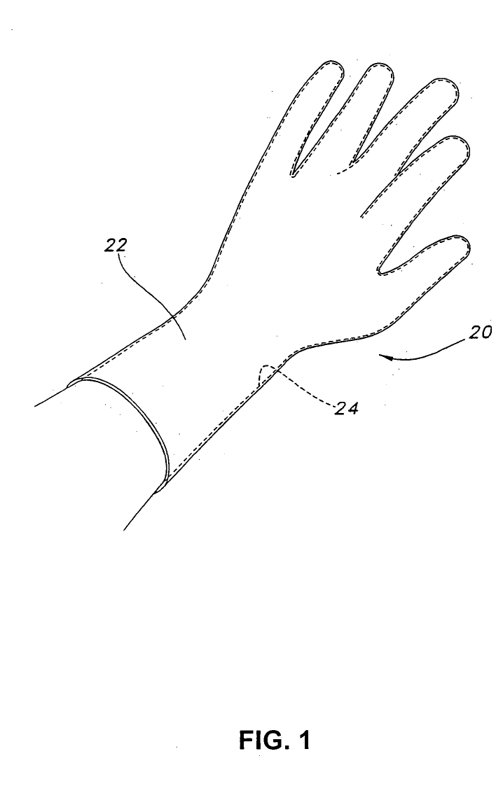

For purposes of illustration, the present invention is discussed in the context of molded or a shaped elastomeric gloves. This, however, in no way limits the breadth of possible applications or extension of the present coagulant composition and associated methods to other types of polymeric or elastomeric articles and products. FIG. 1 shows a representation of a glove 20 formed on a hand-shaped mold, also known as a “former,” using the present invention. The glove 20 includes an exterior surface 22 and an interior surface 24. The former may be made from any suitable material, such as porcelain, ceramic, metal, glass, or the like. The surface of the former defines at least a portion of the surface of the glove 20 to be manufactured. The interior surface 24 is generally also the surface that contacts the wearer's hand.

The fabrication of gloves, as with any kind of shaped polymeric or elastomeric article, starts as each mold or former is first cleaned and conveyed through a preheated oven to evaporate any residual water which may be present. The former then may be dipped into a bath, conventionally, containing a coagulant with a powder source, a surfactant, and water. A conventional powder-containing coagulant, for example, enables a polymer latex to deposit onto the former. When an insoluble salt such as calcium carbonate is used, the powder aids in release of the completed glove from the former. The conventional approach, however, tends to produce a roughened or textured surface, which can significantly effect the material integrity of the substrate. The coagulant coated former is then dipped into a polymer bath, which is generally a natural rubber latex or a synthetic polymer latex. The polymer in the bath may include an elastomeric material that forms the body of the glove.

FIGS. 2A and 2B are optical microscopy (OM) images taken at 10× magnification of surfaces of gloves formed using a powder-free, silicone surfactant-containing solution according to the present invention. The glove shown in FIG. 2A is made using a silicone surfactant-containing coagulant alone, while the glove of FIG. 2B uses a coagulant solution containing a fine powder (i.e., ≦10 microns (μm); typically ˜0.1 μm up to 3 μm or 5 μm) and silicone surfactant. FIG. 2C is an OM image of a surface of a glove formed using a conventional CaCO₃ powder coagulant solution. The coagulant solution can be either an aqueous or alcohol based solution. FIGS. 3A-C are corresponding OM images taken at 20× magnification of the surfaces of the gloves shown in FIGS. 2A-C. Each of the gloves are formed on a former with a bisque ceramic surface. Except for the coagulant formulations employed, the gloves shown in the images of FIGS. 2A-C and 3A-C are produced using substantially identical processing techniques.

When comparing the two sets of Figures, as one can see, the images of gloves in FIGS. 2C and 3C, made according to conventional powdered solution techniques have a highly dimpled microtexture, which results in a dappled or mottled surface. That is, the surface of the gloves formed from a powder-containing solution, without the benefit of the presence of a silicone surfactant formulation, tend to be spotty with wrinkles and coagulant run marks. These defects, it is believed, reflect the solution rheology on the powdered surface of the mold, as shown in FIGS. 6A and 6B. In contrast, the surface of the gloves in FIGS. 2A, 2B, 3A, and 3B, appear as smooth sheets, that are very even and virtually free of defects such as wrinkles or run marks or other surface blemished which can weaken the glove membrane skin, or offer crevices which can shelter microbes and allow bacterial growth on the glove surface. The surface of formers that are coated with silicone surfactant, likewise, is smooth, as seen in FIGS. 5A, 5B, and 5C (even partially dried).

After the coagulant coating is applied, the mold can be coated with an elastomeric material, or elastomer, which becomes the skin or main body of the shaped article. In some embodiments, the elastomer includes natural rubber, which may be supplied as a compounded natural rubber latex, for example, with stabilizers, antioxidants, curing activators, organic accelerators, vulcanizers, and the like. In other embodiments, the elastomeric material may be nitrile butadiene rubber, and in particular, carboxylated nitrile butadiene rubber. Alternatively, the elastomeric material may be a styrene-ethylene-butylene-styrene (S-EB-S) block copolymer, styrene-isoprene-styrene (S-I-S) block copolymer, styrene-butadiene-styrene (S-B-S) block copolymer, styrene-isoprene block copolymer, styrene-butadiene block copolymer, synthetic isoprene, chloroprene rubber, polyvinyl chloride, silicone rubber, polyurethane, or a combination thereof.

Stabilizers can be added, which may include phosphate-type anti-degradants. The antioxidants may be phenolic, for example, 2,2′-methylenebis (4-methyl-6-t-butylphenol). The curing activator may be zinc oxide. The organic accelerator may be dithiocarbamate. The vulcanizer may be sulfur or a sulfur-containing compound. To avoid crumb formation, the stabilizer, antioxidant, activator, accelerator, and vulcanizer may first be dispersed into water by using a ball mill and then combined with the polymer latex.

During the dipping process, the coagulant on the former causes some of the elastomer to become locally unstable and coagulate onto the surface of the former. The elastomer coalesces. The former is withdrawn from the bath and the coagulated layer is permitted to fully coalesce, thereby forming the glove. The former is dipped into one or more baths a sufficient number of times to attain the desired glove thickness. Although conventional thicknesses can be produced, such as in some embodiments where the glove may have a thickness of from about 0.004 inches (0.102 mm) to about 0.012 inches (0.305 mm), according to the invention, the application of the present silicone surfactant in the coagulant permits one to form thin membrane skins. In certain preferred embodiments, one can reduce the thickness of the membrane skin from about 0.12 mm to about 0.07 mm without suffering from pin holes or other surface defects, even in hard to coat areas, such as inter-digit spaces, or so-called “finger crotches.”

After applying the elastomer coating, the former may then be dipped into a leaching tank in which hot water is circulated to remove the water-soluble components, such as residual calcium nitrates and proteins contained in the natural rubber latex solutions and excess process chemicals from the synthetic polymer latex. This leaching process may generally continue for about 12 minutes at a water temperature of about 120° F. The glove is then dried on the former to solidify and stabilize the glove. It should be understood that variations in the conditions, processes, and materials used to form the glove may dictate the precise processing parameters. Other layers may be formed by including additional dipping processes. Such layers may be used to incorporate additional features into the glove.

The glove is then sent to a curing station where the elastomer is vulcanized, typically in an oven. The curing station initially evaporates any remaining water in the coating on the former and then proceeds to a higher temperature vulcanization. The drying may occur at a temperature of from about 85° C. to about 95° C., and the vulcanizing may occur at a temperature of from about 110° C. to about 120° C. For example, the glove may be vulcanized in a single oven at a temperature of 115° C. for about 20 minutes. Alternatively, the oven may be divided into four different zones with a former being conveyed through zones of increasing temperature. For instance, the oven may have four zones with the first two zones being dedicated to drying and the second two zones being primarily for vulcanizing. Each of the zones may have a slightly higher temperature, for example, the first zone at about 80° C., the second zone at about 95° C., a third zone at about 105° C., and a final zone at about 115-120° C. The residence time of the former within each zone may be about ten minutes. The accelerator and vulcanizer contained in the latex coating on the former are used to crosslink the elastomer. The vulcanizer forms sulfur bridges between different elastomer segments and the accelerator is used to promote rapid sulfur bridge formation.

Upon being cured, but before being transferred to a stripping station where the glove is removed from the former, various post-formation treatments may be applied directly to the exposed surface of the glove on the former. To reiterate, since the glove commonly is inverted or turned inside out as it is stripped from the former, the exposed, exterior surface of the glove on the former becomes the interior surface of the glove. The glove can remain on the former while the post-formation treatments are applied. This eliminates an extra step of reinverting the glove as is done conventionally after treatment is applied. Individual gloves may be treated or a plurality of gloves may be treated simultaneously. Any suitable treatment technique may be used, including for example, dipping, spraying, immersion, printing, tumbling, or the like.

In this way, modification of the final interior surface of the glove is simplified. For instance, one can form a donning layer or apply lubricants to the exposed surface of the glove, which when stripped and inverted becomes the final wearer-contact or interior surface. Halogenation (e.g., chlorination) of the interior surfaces may be performed in any suitable manner, including: (1) direct injection of chlorine gas into a water mixture, (2) mixing high density bleaching powder and aluminum chloride in water, (3) brine electrolysis to produce chlorinated water, and (4) acidified bleach. Examples of such methods are described in U.S. Pat. No. 3,411,982 to Kavalir; U.S. Pat. No. 3,740,262 to Agostinelli; U.S. Pat. No. 3,992,221 to Homsy, et al.; U.S. Pat. No. 4,597,108 to Momose; U.S. Pat. No. 4,851,266 to Momose; and U.S. Pat. No. 5,792,531 to Littleton, et al., which are each herein incorporated by reference in their entirety. In one embodiment, for example, chlorine gas is injected into a water stream and then fed into a chlorinator (a closed vessel) containing the glove. The concentration of chlorine may be altered to control the degree of chlorination. The chlorine concentration may typically be at least about 100 parts per million (ppm). In some embodiments, the chlorine concentration may be from about 200 ppm to about 3500 ppm. In other embodiments, the chlorine concentration may be from about 300 ppm to about 600 ppm. In yet other embodiments, the chlorine concentration may be about 400 ppm. The duration of the chlorination step may also be controlled to vary the degree of chlorination and may range, for example, from about 1 to about 10 minutes. In some embodiments, the duration of chlorination may be about 4 minutes.

While still within the chlorinator, the chlorinated glove or gloves may then be rinsed with tap water at about room temperature. This rinse cycle may be repeated as necessary. Excess water is then drained off of the gloves, as they remain on the former. Alternatively, one may adapt off-line post processing steps at this point for additional advantages of on-line treatment of the donning side of the glove. For instance, a lubricant composition may then be added. The lubricant forms a layer on at least a portion of the interior surface to further enhance donning of the glove. In one embodiment, this lubricant may contain a silicone or silicone-based component. The lubricant solution is then drained from the chlorinator and may be reused if desired. It should be understood that the lubricant composition also may be applied at a later stage in the forming process, and may be applied using any technique, such as dipping, spraying, immersion, printing, tumbling, or the like.

Post-formation processing of the final exterior surface of solidified gloves, generally is not necessary according to the present invention, since there is no powder to remove, nor is off-line halogenation needed to decrease tackiness of the exterior surface. The virtues of tack reduction, it is believed involves the creation of a smoother dip coat of the silicone surfactant dispersed in the present coagulant solution. Once a glove is removed from its former, the silicone surfactant residue can remain on the outer surface, the gripping side, of the glove. The silicone residue can help reduce tackiness of the glove's surface and minimize block resistance of the surface of sliding over against itself. This characteristic can eliminate the need, as currently done, to post-treat gloves to remove surface tackiness, and save both time and processing costs. This feature makes stripping and packaging of the gloves easier and more automation friendly.

Nonetheless, the present invention does not preclude various post-formation processes, including application of one or more treatments to at least one surface of the glove. For example, once stripped from the former, any treatment, or combination of treatments, may then be applied to the exposed exterior surface of the glove. The stripping station may involve automatic or manual removal of the glove from the former. For example, in one embodiment, the glove is manually removed. It should be understood that any method of removing the glove from the former may be used, including a direct air or water removal process that does not result in inversion of the glove.

### EXAMPLES OF SILICONE SURFACTANT COAGULANT FORMULATIONS

Having described the advantages and attributes of the present invention in general terms, the silicone surfactant coagulant was tested in the fabrication of some articles, such as gloves. The following composition examples are provided as illustrations, and are not intended to be limiting of the invention. Each of the coagulant formulations in Examples 1 through 4, below, allowed one to create an elastomeric, either natural rubber or synthetic polymer based, glove that was easily stripped off of its former without the use of any powder between the mold surface and the glove membrane. Example 5. involved the incorporation of a small amount of fine CaCO₃ powder, the results of which is shown in FIGS. 1B, 2B, and 3B, under different magnifications.

Generally speaking, the gloves were all manufactured using conventional equipment and techniques except for the coagulant formulations of the present invention.

### Example 1

A coagulant dispersion is prepared according to the following formulation, in weight percent (wt. %):

| | wt. % | grams | |
|---|---|---|---|
| water | ˜73.77 | ˜5,000 | g. |
| calcium nitrate tetrahydrate | ˜25.64 | ˜1,738 | g. |
| silicone surfactant (Masil SF19) | ˜0.59 | ˜40 | g. |

We start with a container of water, to which all other ingredients may be added in any order. Conventional techniques are used such as stirring or mechanically mixing. Although any type of clean water can be used, in certain embodiments, deionized water is preferred in preparing the example coagulants.

The coagulant solution is heated to about 54° C. A bisque ceramic formers is preheated to about 65° C., and dipped into the coagulant utilizing conventional equipment and techniques. After dipping with the coagulant, the ceramic former is slowly pulled out of the coagulant dispersion and then rotated to let the coagulant dispersion be uniformly distributed over the surface of the ceramic former. The coagulant coated formers are then dipped into a conventional nitrile latex compound containing curatives and pigments. The formers were then submersed in a water bath at 25° C. for 5 minutes. They were then dried at 90° C. and cured at 140° C. in a hot air oven. For this example, drying time and curing time were about 15 minutes, respectively. The glove was then easily stripped from the mold without the use of any powder between the mold and the glove. That is, the glove was removed from the mold by finger-gripping and pulling the outermost cuff/bead of the glove without tugging or pulling to overcome unusual resistance in the form of sticking or binding.

### Example 2

In another example, similar to Example 1, the following dipping coagulant was prepared:

| | wt. % | grams | |
|---|---|---|---|
| deionized water | ˜73.77 | 5,000 | g. |
| calcium nitrate tetrahydrate | 25.64 | 1,738 | g. |
| silicone surfactant (Masil SF19) | 1.18 | 80 | g. |

A glove of Example 2 and a glove of Example 1 are similar in physical properties, and show little difference when extracted by water.

### Example 3

Another formulation, similar to Examples 1 and 2, is prepared but with the addition of a defoamer:

| | wt. % | grams | |
|---|---|---|---|
| water | 65.18 | 5000 | g. |
| calcium nitrate tetrahydrate | 33.89 | 2600 | g. |
| silicone surfactant | 0.78 | 60 | g. |
| de-webber/defoamer surfactant | 0.14 | 11 | g. |
| (Surfynol TG) | | | |

Alternatively, the coagulant dispersion could contain:

| | wt. % | grams | |
|---|---|---|---|
| water | ˜65.35 | ˜5,000 | g. |
| calcium nitrate tetrahydrate | ˜33.98 | ˜2,600 | g. |
| silicone surfactant (Masil SF19) | ˜0.52 | ˜40 | g. |
| de-webber/defoamer (Surfynol TG) | ˜0.14 | ˜11 | g. |

Surfynol TG is a de-webber/defoamer surfactant available from Air Products & Chemicals Inc, Allentown, Pa., and Masil SF19 is a silicone preparation available from BASF Corporation. As in the prior example, the coagulant ingredients are added, blended, and stirred together utilizing conventional techniques for making such coagulant mixtures, which in some embodiments may include some insoluble species. A ceramic bisque former is heated to 40-50° C. and then dipped into the 35-45° C. coagulant dispersion for about 5-10 seconds. The resulting glove, as in Examples 1 and 2, was easily removed from the mold without any powder between the mold and the glove.

### Example 4

In another example, a coagulant formulation is prepared using:

| | wt. % | grams | |
|---|---|---|---|
| water | ˜83.34 | ˜7,000 | g. |
| calcium nitrate | ˜14.70 | ˜1,235 | g. |
| Silicone surfactant (Silsurf D208-212) | ˜1.96 | ˜165 | g. |

Silsurf D208-212 is a silicone polyether with molecular weight of about 2700, available from Siltech Corporation of Toronto, Canada and Dacula, Ga. As in all of these examples, a combination magnetic stirrer/heating plate was used. For larger batches, a higher shear mechanical mixer could be used.

The formulation was mixed and heated to about 54° C. A glove former is preheated to about 70° C., and dipped into the coagulant formulation. After the former is air-dried and rotated for approximately 3 minutes, it is then dipped into a nitrile latex formulation. The nitrile latex formulation contained a carboxylated nitrile latex, along with suitable curing agents and pigments. The total solids content of the latex formulation was diluted to 25% in order to prepare gloves of a thin membrane skin. After the latex dip, the former containing the gelled glove is leached in water at about 35° C. for 4 minutes to remove the calcium nitrate and excess latex emulsifiers. The former with glove is then placed in an oven at a temperature of 80° C. for about 10 minutes, then into a 120° C. oven for about 10 minutes. After cooling, the glove is chlorinated using conventional techniques by placing the former with glove in a bath of chlorine water (1400 ppm chlorine) for about 10 seconds, and then rinsed with water.

Easily removed from the former, the glove is powder free on both inner and outer surfaces of the glove. When manually pressing two sections of the glove together, little or no residual surface tack remain on either side of the glove. This was gauged by observing that the glove surfaces required very minimal, if any, force to separate the sections, as compared to the usual level of force required to separate two sections of a glove that contained no powder, no residual silicone surfactant on the surface, and/or underwent no chlorination. The outer surface of the gloves were tack-free (i.e., the finger sections could be squeezed together manually, without sticking to one another).

### Example 5

A coagulant solution or mixture, in which non-soluble ingredients such as small amounts of powder are added, containing:

| | wt. % | grams | |
|---|---|---|---|
| Water | ˜74.26 | 6000 | g. |
| Calcium Nitrate | ˜24.75 | 2000 | g. |
| Silicone Surfactant (Silsurf D208-212) | ˜0.495 | 40 | g. |
| Calcium Carbonate | ˜0.495 | 40 | g. |

In this case, the silicone surfactant is a less effective wetting agent than the silicone surfactants in the other examples. This is due to a higher level of hydrocarbon content which may make it more substantive to a rubber surface. Addition of a small amount of calcium carbonate helped to give an even distribution of the coagulant onto the mold, without being present in high enough concentration to cause pooling or surface irregularity.

The present invention has been described in general and in detail by way of examples. Persons of skill in the art understand that the invention is not limited necessarily to the embodiments specifically disclosed, but that modifications and variations may be made without departing from the scope of the invention as defined by the following claims or their equivalents, including other equivalent components presently known, or to be developed, which may be used within the scope of the present invention. Therefore, unless changes otherwise depart from the scope of the invention, the changes should be construed as being included herein.

We claim:

1. A coagulant formulation for use in making an elastomeric product, the coagulant comprising: a silicone surfactant that is miscible in either an aqueous or solvent based medium, a mono-, di-, or trivalent metallic salt or combinations thereof, and optionally wetting agents or defoamers, wherein said coagulant is applicable directly to a surface without fouling said surface.

2. The coagulant formulation according to claim 1, wherein said silicone surfactant includes a poly-methylsiloxane backbone.

3. The coagulant formulation according to claim 2, wherein said silicone surfactant has a general structure according to the following: 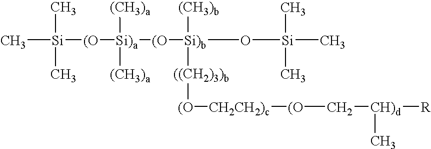
where, R is a —CH₃, —OH, alkyl alcohol, or alkyl polyol group; a, c, and d are integers greater than 0; and b≧1.

4. The coagulant formulation according to claim 1, wherein said composition in weight percent comprises: about 5-50% of a coagulant salt or acid, about 0.001-85% silicone surfactant; about 50-90% aquesous or alcohol solvent; and an effective amount of up to about 2% of a defoamer, or up to about 3% of an additional wetting agent.

5. The coagulant formulation according to claim 1, wherein said metallic salts include nitrate, sulfate, or chloride salts of calcium, aluminum, zinc, or ammonium.

6. The coagulant formulation according to claim 1, wherein said composition is free of powder particles.

7. The coagulants according to claim 1, wherein said coagulant is acidic and may be selected from hydrochloric, formic, or acetic acids.

8. A method of fabricating a polymeric article, the method comprising:
a) providing a mold having a cleaned and prepared surface;
b) providing a composition for a coagulant solution having a silicone surfactant that is miscible in either an aqueous or solvent based solution, either a mono-, di-, trivalent metallic salt or combinations thereof, and optionally wetting agents or defoamers;
c) applying a coating of said coagulant solution to said mold surface;
d) applying a coating of either a polymer-containing liquid, a colloidal emulsion, or a solvent-based polymer medium to said coagulant coated mold surface;
e) removing salt residue from said article
f) drying and curing said article.

9. The method according to claim 8, wherein said silicone surfactant in said coagulant solution is applied directly to said mold surface.

10. The method according to claim 8, wherein said mold surface is powder-free.

11. The method according to claim 8, wherein said coagulant solution imparts a smooth, glassy surface to said mold surface.

12. The method according to claim 8, wherein the susceptibility of said silicone surfactant-coated surface to wetting by either a polymer-containing liquid, an colloidal emulsion, or a solvent-based polymer medium is greater than a comparable mold surface not coated with said silicone surfactant.

13. The method according to claim 8, wherein said coagulant solution has a reduced surface tension, relative to a coagulant solution absent a silicone surfactant.

14. The method according to claim 13, wherein said surface tension of said coated mold surface is ≦45 dynes/cm.

15. A method for preparing and using a coagulant solution, the method comprises: a) providing an aqueous- or solvent-miscible silicone surfactant; b) providing an aqueous or solvent-based coagulant solution having either a mono-, di-, trivalent metallic salt or combinations thereof, and optionally wetting agents or defoamers; c) mixing together said silicone surfactant and coagulant solution; and d) applying said prepared silicone surfactant-containing solution directly to a prepared surface.

16. The method according to claim 15, wherein said method further comprises: heating said prepared solution to a temperature of up to about 60° C.

17. The method according to claim 16, wherein said prepared solution is heated to a temperature of between about 15° C. to 55° C.

18. The method according to claim 15, wherein said silicone surfactant includes a poly-methylsiloxane backbone.

19. The method according to claim 18, wherein said silicone surfactant has a general structure according to the following: 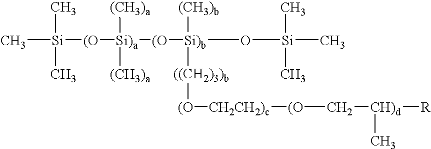
where, R is a —CH₃, —OH, alkyl alcohol, or alkyl polyol group; a, c, and d are integers greater than 0; and b≧1.

20. The method according to claim 15, wherein the susceptibility of said silicone surfactant-coated surface to wetting by either a polymer-containing liquid, an colloidal emulsion, or a solvent-based polymer medium is greater than a comparable mold surface not coated with said silicone surfactant.

21. The method according to claim 15, wherein said coated surface has a surface tension of ≦45 dynes/cm.

22. An polymeric article having an gripping or external surface characterized as either having present at least a residue of a miscible silicone surfactant or being free of halogenation residue on said surface, or having substantially no block resistance of said surface to sliding over against itself.

23. The polymeric article according to claim 22, wherein said residue of silicone surfactant is present in a substantially even coating on said external surface.

24. The polymeric article according to claim 22, wherein said external surface has an even surface and absent surface defects.

25. The polymeric article according to claim 22, wherein said article is free of powder particles.

26. The polymeric article according to claim 22, wherein said article is a membrane, glove, condom, catheter, tubing, or balloon.
